(19) United States
(12) Patent Application Publication
(10) Pub. No.: US 2026/0039229 A1
(43) Pub. Date: Feb. 5, 2026

(54) ARRANGEMENT FOR GENERATING AND TRANSMITTING CONTROL SIGNALS

(71) Applicant: Robert Bosch GmbH, Stuttgart (DE)

(72) Inventors: Attila Groepler, Stuttgart (DE); Christian Karcher, Buehl (DE)

(21) Appl. No.: 19/286,502

(22) Filed: Jul. 31, 2025

(30) Foreign Application Priority Data
Jul. 31, 2024 (DE) 10 2024 207 199.4

(51) Int. Cl. H02P 6/14; H02P 6/24

(52) U.S. Cl. CPC H02P 6/14; H02P 6/24

(57) ABSTRACT

Arrangement for generating control signals (22) for actuating an electric motor (10), having at least one microcontroller (12), at least two driver units (14) and at least one bus, wherein the at least one microcontroller (12) and the at least two driver units (14) are connected to each other via the at least one bus and a unit (30) for generating the control signals (22) is provided in the at least two driver units (14).

### BACKGROUND

The invention relates to an arrangement for generating and transmitting control signals for controlling multiple output stages for an electric motor.

In many vehicle components, such as brakes, electric power steering, etc., the actuators are implemented via electric drives. These electric drives typically consist of three-phase or integer multiples of three-phase EC motors (EC: electrically commutated) and their control units.

DC/AC converters are used to control the drive, which in turn regularly have a computer unit, several output stages and driver units with which the output stages are actuated. The output stage drivers are actuated via a bus, typically the SPI bus, and via discrete signals.

It is to be expected that higher demands will be placed on the availability of these drives in by-wire systems.

In known embodiments, the following actuators are required for by-wire vehicles:
an actuator on the steering rack SRA (Steering Rack Actuator),
a driver feedback unit and a steering request sensor SWA (Steering Wheel Actuator),
optionally an actuator on the rear steering rack SRA rear (Steering Rack Actuator Rear),
a front left brake actuator (Braking Actuator FL),
a front right brake actuator (Braking Actuator FR),
a rear left brake actuator (Braking Actuator RL),
a rear right brake actuator (Braking Actuator RR).

It should also be noted that a control device must be active or fail active for an x-by-wire application. This means that in the event of an E/E fault (E/E: electrical/electronic), the steering and braking functions must still be available. For this reason, the motors of the SRA and SWA are six-phase versions. It should be noted that there are also three-phase SWAs. The motor control of the SRA and the SWA therefore takes place via two power stages (PS), e.g. B6 bridges, and correspondingly via two driver units or output stage drivers, e.g. gate driver units (GDU). A schematic illustration of this can be found in FIG. 1, which is explained in more detail below.

Publication DE 10 2009 045 023 A1 describes a method for communication between a microcontroller and an output stage module via a communication link. In this case, the microcontroller transmits a signal sequence via a microsecond bus.

A data transmission device is known from the publication DE 197 33 748 C2. The device is used for unidirectional serial data transmission from a transmitting device of a microcontroller to an output stage IC of a vehicle control unit.

Publication EP 1 817 208 B1 describes an integrated circuit in a control device with a first evaluation of at least one acceleration signal to enable at least one ignition output stage.

### SUMMARY

Against this background, an arrangement for generating and transmitting control signals for controlling multiple output stages according to the disclosure and a method for generating control signals according to the disclosure are presented.

The arrangement presented is based on the realization that high-availability drive systems, such as by-wire applications or applications in the steering and braking area, require a redundant supply, control and diagnosis of the power electronics. This redundancy is also required in the hardware architecture. The redundant architectural elements and electronic components are connected to each other via a large number of interfaces and signals. The output stage driver in particular should be connected to more than one computing unit. This means that instead of around 20 signals, there are now around 40 signals to contact.

The arrangement presented is used to generate control signals to control an output stage for an electric motor. The arrangement has at least one microcontroller, at least two driver units and at least one bus. The at least one microcontroller and the at least two driver units are connected to each other via the at least one bus. Furthermore, the at least two driver units typically each contain a unit for generating the control signals.

The bus offers the possibility of bi-directional communication between several participants. In this case, three or more participants, i.e. microcontrollers and driver units, are typically provided. The bus enables arbitration. It is also possible to specify that information on the bus that is carried by the signals on the bus is only assigned to certain subscribers. Furthermore, fault-tolerant operation can be guaranteed.

The bus may be configured such that a direct and/or an indirect connection is configured between the at least one microcontroller and the at least one driver unit. There is then typically a direct and/or parallel indirect connection between individual subscribers, so that if one of the two connections fails, further communication between these subscribers can be guaranteed.

This introduces bus communication between the microcontroller and the output stage driver. This bus can have a ring structure (daisy chain) or a tree structure (multidrop).

Further advantages and embodiments of the invention are apparent from the description and the accompanying drawings.

It is understood that the features specified hereinabove and the features yet to be explained hereinafter can be used not only in the respectively specified combination, but also in other combinations, or on their own, without departing from the scope of the present invention.

### BRIEF DESCRIPTION OF THE DRAWINGS

FIG. 1 shows a schematic, highly simplified representation of an actuating system for an electric motor according to the method presented.

FIGS. 2 to 7 show versions of the presented arrangement for generating control signals with different ring structures.

FIGS. 8 to 11 show versions of the presented arrangement for generating control signals with different tree structures.

FIG. 12 shows a schematic illustration of an exemplary hardware architecture without bus.

FIG. 13 shows a schematic illustration of an exemplary hardware architecture with bus.

### DETAILED DESCRIPTION

The invention is illustrated schematically in the drawings on the basis of embodiments and is described in the following with reference to said drawings.

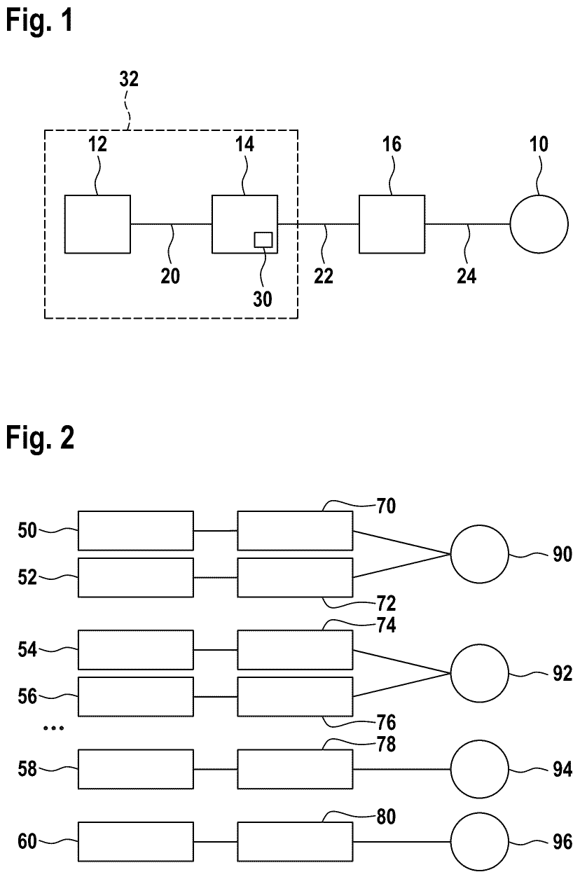

FIG. 1 shows a highly simplified, purely schematic illustration of a control according to the method presented for an electric machine, in this case an electric drive or an electric motor 10. The illustration shows a microcontroller 12, a driver unit 14 and an output stage 16. The microcontroller 12 is used to control the operation of the motor 10, for which purpose it provides control signals 20 and sends them to the driver unit 14 via a bus. The driver unit 14, which comprises, for example, gate driver units (GDU), generates control signals 22 for the output stage 16, which is designed, for example, as a bridge. For this purpose, a unit 30 for generating the control signals 22 is provided in the driver unit 14. The output stage 16 in turn generates the current signals 24 and thus the current for operating or supplying the motor 10 or the phases of the motor 10.

Unit 30 uses timers to generate the PWM signals for switching the MOSFETs of the B6 bridge on and off. The unit 30 can be located both in the driver unit 14 and in the microcontroller 12.

An arrangement 32 for generating control signals 22 for controlling the output stage 16, which in turn supplies the motor 10, i.e. the output stage 16 for the motor 10, is outlined with a dashed line.

To simplify the illustration, only one driver unit (14) is shown. At least two driver units (14) are provided in the arrangement presented.

FIG. 2 shows a motor configuration for by-wire steering and braking on the front axle. The illustration shows as driver units a first gate driver unit GDU 1 50, a second gate driver unit GDU 2 52, a third gate driver unit GDU 3 54, a fourth gate driver unit GDU 4 56, a fifth gate driver unit GDU 5 58 and a sixth gate driver unit GDU 6 60. The illustration also shows a first output stage PS 1 70, a second output stage PS 2 72, a third output stage PS 3 74, a fourth output stage PS 4 76, a fifth output stage PS 5 78 and a sixth output stage PS 6 80. Also shown are a first electric motor 90 for SRA, a second electric motor 92 for SWA, a third electric motor 94 for an electromechanical brake (EMB) at the front left (FL) and a fourth electric motor 96 for an EMB at the front right (FR).

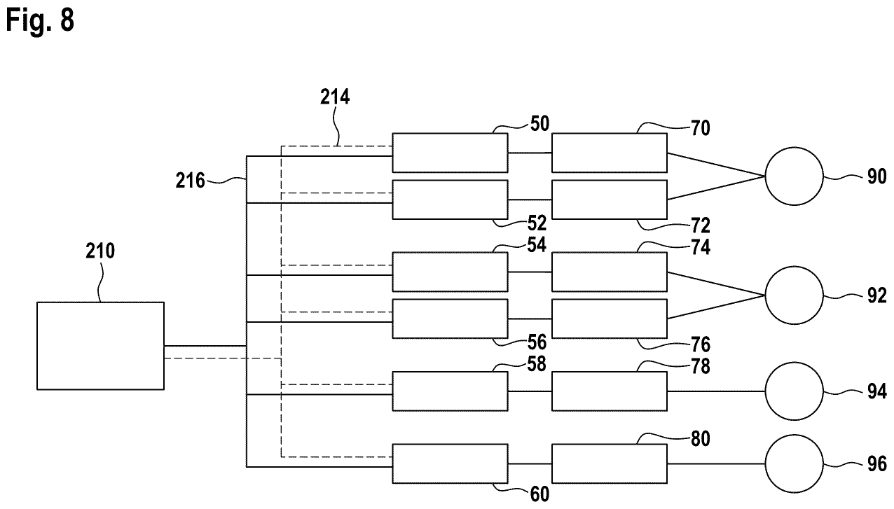

Ring structures as shown in the following figures are conceivable for a motor configuration as shown in FIG. 2. It should be noted that the ring structure 6 as shown in FIG. 8 offers the highest availability.

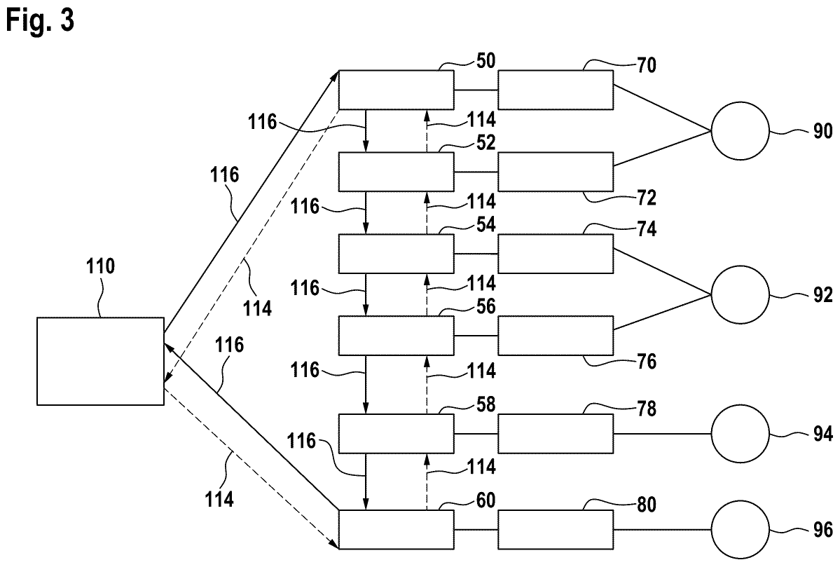

FIG. 3 shows the motor configuration of FIG. 2 with a microcontroller 110 and a first bus 114 and a second bus 116, which form a ring structure (ring structure 2) and which enable the transmission of control signals between the microcontroller 110 and the gate driver units 50 to 60.

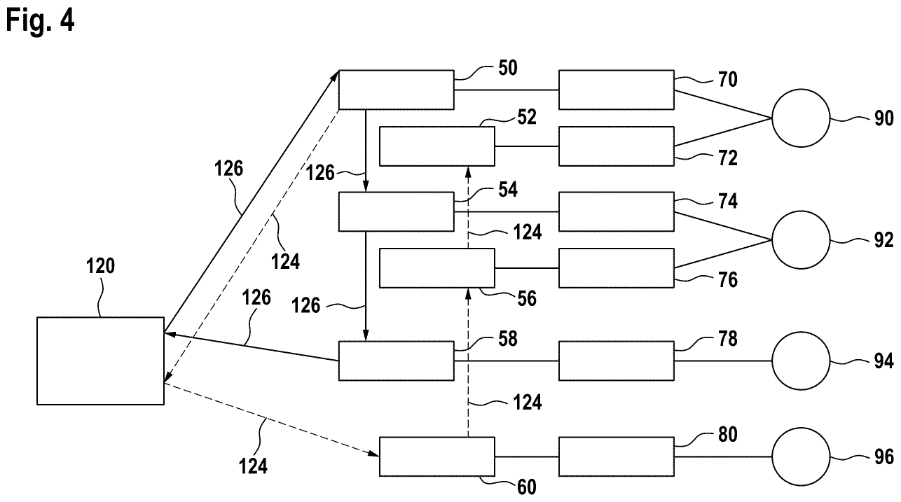

FIG. 4 shows the motor configuration of FIG. 2 with a microcontroller 120 and a first bus 124 and a second bus 126, which form a ring structure (ring structure 3) and which enable the transmission of control signals between the microcontroller 120 and the gate driver units 50 to 60.

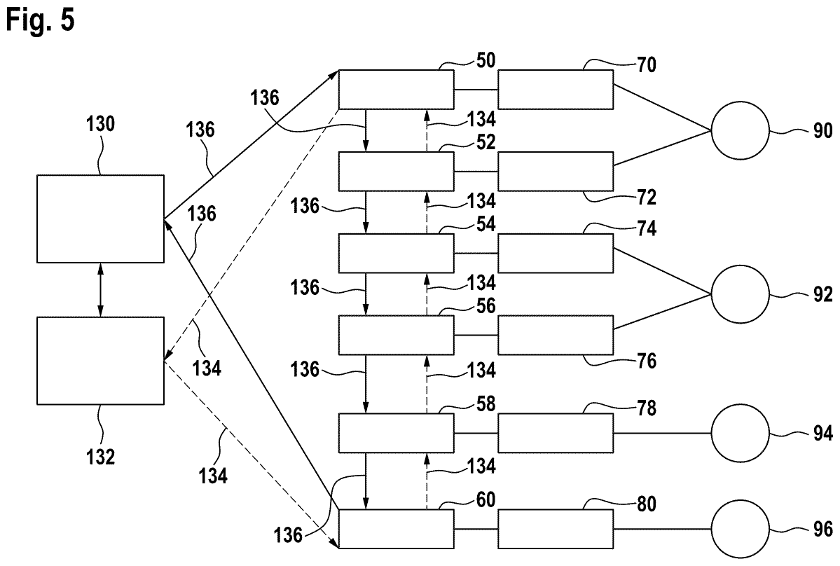

FIG. 5 shows the motor configuration of FIG. 2 with a first microcontroller 130, a second microcontroller 132 and a first bus 134 and a second bus 136, which form a ring structure (ring structure 4) and which enable the transmission of control signals between the microcontrollers 130 and 132 and the gate driver units 50 to 60.

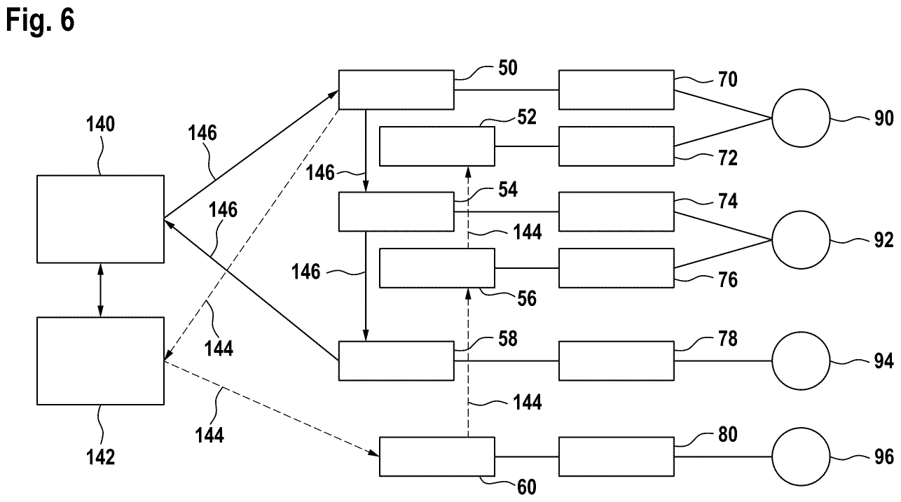

FIG. 6 shows the motor configuration of FIG. 2 with a first microcontroller 140, a second microcontroller 142 and a first bus 144 and a second bus 146, which form a ring structure (ring structure 5) and which enable the transmission of control signals between the microcontrollers 140 and 142 and the gate driver units 50 to 60.

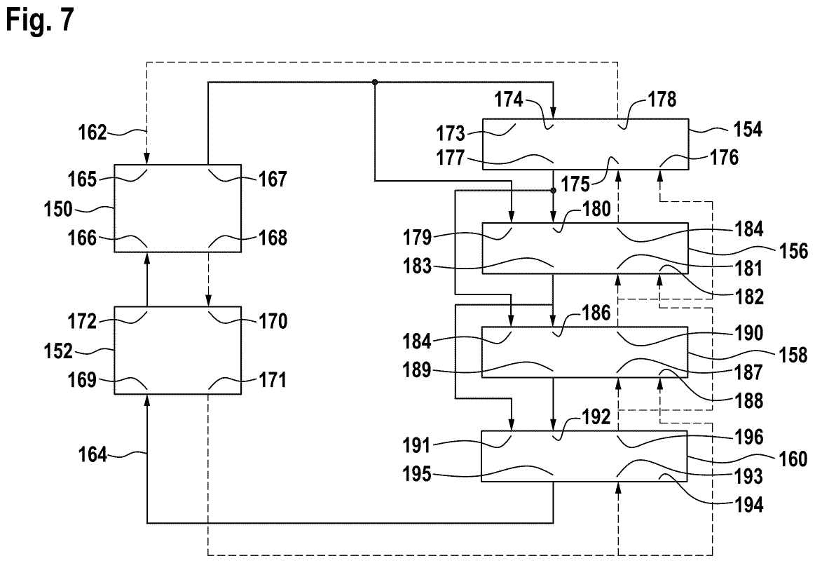

FIG. 7 shows the ring structure 6. The illustration shows a first microcontroller 150 and a second microcontroller 152. Furthermore, the embodiment shows a first driver unit 154, a second driver unit 156, a third driver unit 158 and a fourth driver unit 160, which are designed as gate driver units. A first bus 162 and a second bus 164 are provided for communication between the microcontrollers 150, 152 and the driver units 154, 156, 158 and 160.

The first microcontroller 150 has inputs In1 165 and In2 166 and outputs Out1 167 and Out2 168. The second microcontroller 152 has inputs In1 169 and In2 170 and outputs Out1 171 and Out2 172. The first driver unit 154 has inputs InA1 173, InA2 174, InB1 175, InB2 176 and outputs OutA 177 and Out 178.

The second driver unit 156 has inputs InA1 179, InA2 180, InB1 181, InB2 182 and outputs OutA 183 and Out 184. The third driver unit 158 has inputs InA1 185, InA2 186, InB1 187, InB2 188 and outputs OutA 189 and Out 190. The fourth driver unit 160 has inputs InA1 191, InA2 192, InB1 193, InB2 194 and outputs OutA 195 and Out 196.

This embodiment offers even greater availability compared to the other embodiments. A fault in a GDU (gate driver unit) does not cause the entire ring to fail, as would be the case with the other ring structures. The defective GDU can be “skipped.” Another GDU then takes over. the functionality of the defective GDU. Furthermore, both rings are still functional.

In the embodiments shown in FIGS. 3 to 7, both direct and indirect connections between the participants are realized.

Tree structures are still viable:

FIG. 8 shows the motor configuration of FIG. 2 with a microcontroller 210 and a first bus 214 and a second bus 216, which form a tree structure (tree structure 2) and which enable the transmission of control signals between the microcontroller 210 and the gate driver units 50 to 60.

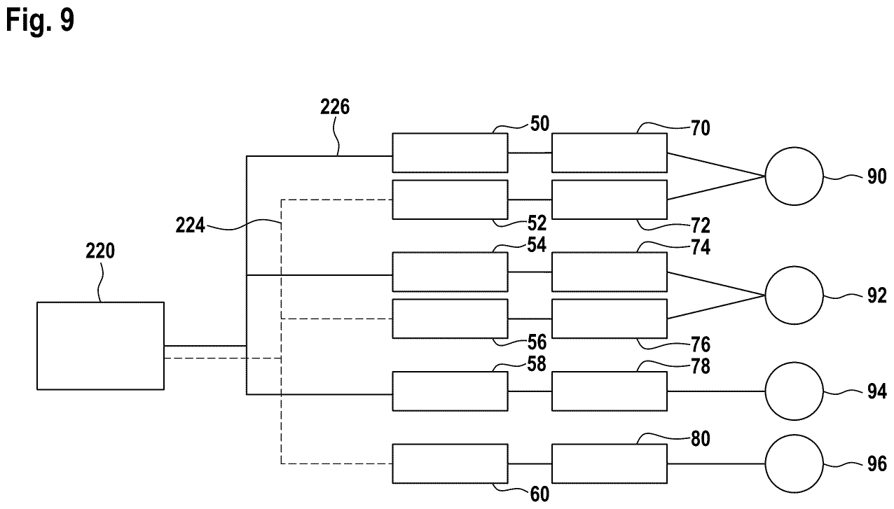

FIG. 9 shows the motor configuration of FIG. 2 with a microcontroller 220 and a first bus 224 and a second bus 226, which form a tree structure (tree structure 3) and which enable the transmission of control signals between the microcontroller 220 and the gate driver units 50 to 60.

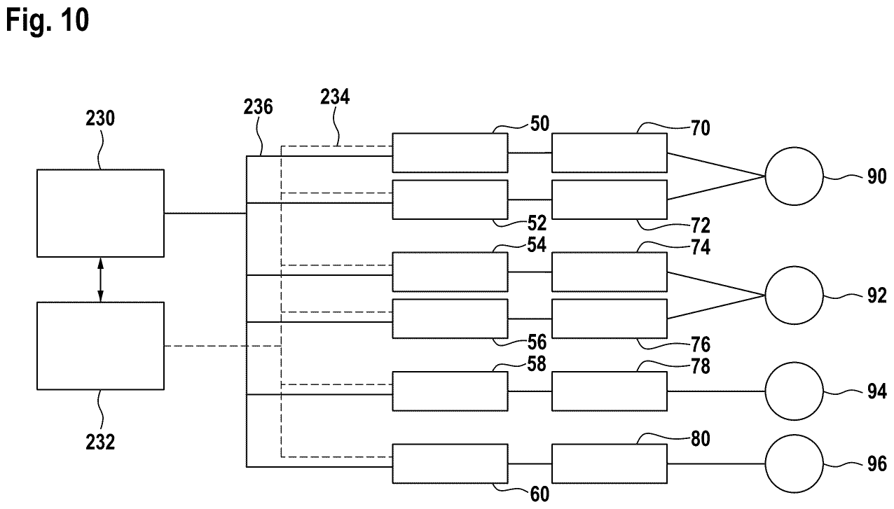

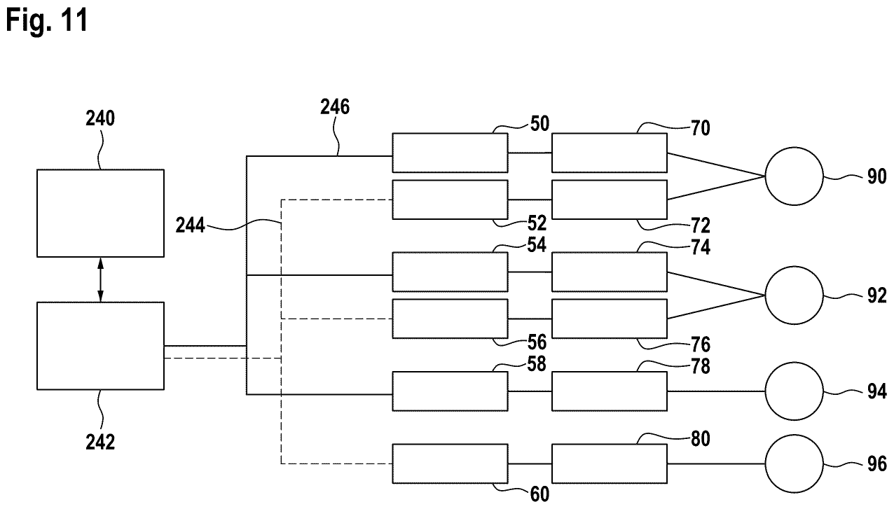

FIG. 10 shows the motor configuration of FIG. 2 with a first microcontroller 230, a second microcontroller 232 and a first bus 234 and a second bus 236, which form a tree structure (tree structure 4) and which enable the transmission of control signals between the microcontrollers 230 and 232 and the gate driver units 50 to 60.

FIG. 11 shows the motor configuration of FIG. 2 with a first microcontroller 240, a second microcontroller 242 and a first bus 244 and a second bus 246, which form a ring structure (tree structure 5) and which enable the transmission of control signals between the microcontrollers 240 and 242 and the gate driver units 50 to 60.

Direct and indirect connections are thus realized in the designs of FIGS. 8 to 11.

One or two buses are therefore used to connect the microcontrollers to the output stage drivers. The PWM signals are generated in the output stage driver, i.e. the driver unit, in contrast to the known procedure. However, the motor control still takes place in the microcontroller.

This simplifies the wiring between microcontrollers and output stage drivers in a control device that is used to control several actuators in a vehicle. Despite this simplification, the availability of the overall system can be increased. If a power stage driver fails, all other output stage drivers can be reached via the bus. In addition, if one computing unit fails, the second computing unit can control and diagnose all output stage drivers.

In addition, the layout of corresponding control devices can be simplified, as the wiring between the microcontrollers and the output stage drivers is considerably simplified.

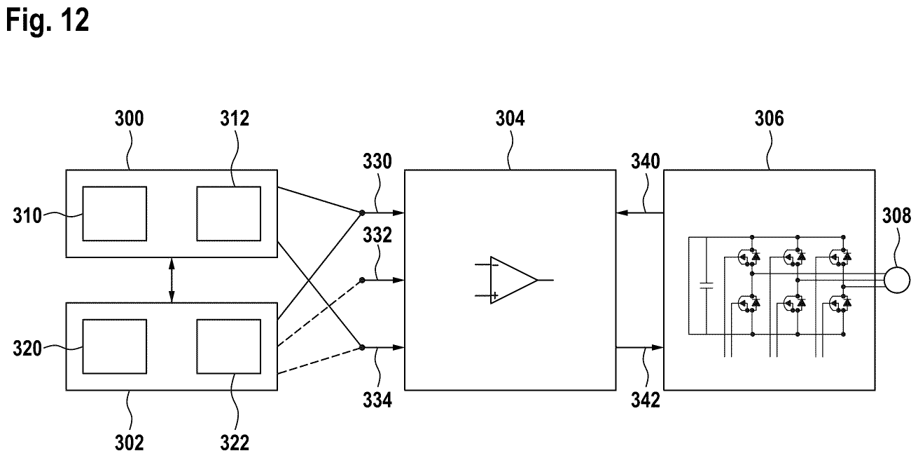

FIG. 12 shows an exemplary hardware architecture without bus. The embodiment shows a first microcontroller 300, a second microcontroller 302, a gate driver unit 304 and an output stage 306, which is designed as a B6 bridge. A motor 308 is operated with the arrangement shown. A motor controller 310 and a unit 312 for generating a PWM signal are provided in the first microcontroller 300. Accordingly, the second microcontroller 302 has a motor controller 320 and a unit 322 for generating a PWM signal. The two microcontrollers 300, 302 output: four SPI signals 330, six PWM signals 332 and four to seven diagnostic signals. The driver unit 304 outputs: nine voltage signals 340 and six PWM signals.

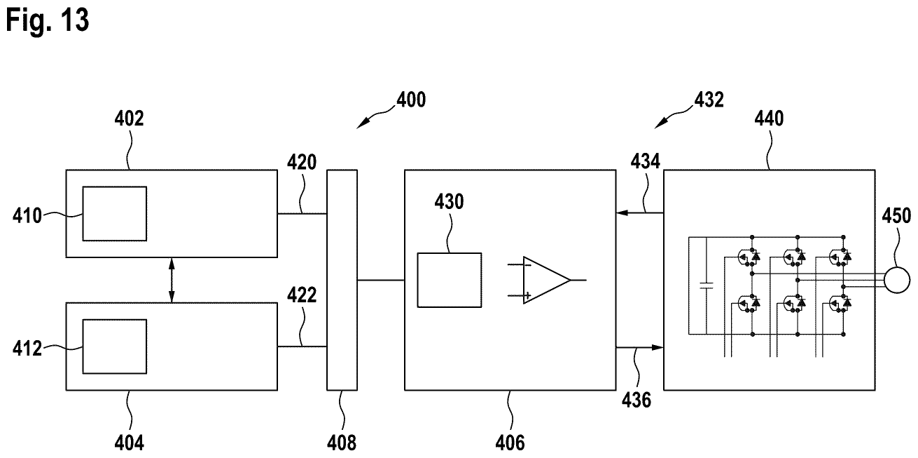

FIG. 13 shows an embodiment of the presented arrangement, which is designated overall by the reference numeral 400 and comprises a first microcontroller 402, a second microcontroller 404 and a driver unit 406, which is designed as a gate driver unit. The two microcontrollers 402, 404 and the driver unit 406 are connected to each other via a bus 408.

The first microcontroller 402 has a motor controller 410, and the second microcontroller 404 also has a motor controller 412. The first microcontroller 402 outputs two to four control signals 420 to the bus 408. Similarly, the second microcontroller 404 outputs two to four control signals 422 to the bus 408. The driver unit 406 controlled via the bus 408 comprises a unit 430 for generating control signals 432, which in turn comprise nine voltage signals 434 and six PWM signals 436. An output stage 440 is actuated, which in this case is designed as a B6 bridge and which in turn supplies an electric motor 450.

It was thus recognized that currently available output stage drivers are not suitable for use in a control device with bus communication between the microcontroller(s) and the GDU. Not all PWM signals can be transmitted via a bus, particularly due to the timing requirements for the PWM signal. Accordingly, the function of generating the control signal, e.g. the control signal, which is then referred to as “PWM generation”, is part of the driver unit; reference is made to FIGS. 12 and 13.

A comparison of FIGS. 12 and 13 shows directly that the layout of control devices with bus communication between the microcontroller and the output stage driver is simplified because the number of signals emanating from the microcontroller is reduced from 14 to 17 to two to four signals.

1. An arrangement for generating control signals (22, 432) for actuating an output stage (60, 70, 72, 74, 78, 80, 440) for an electric motor (10, 90, 92, 94, 96, 450), the arrangement comprising:
at least one microcontroller (12, 110, 120, 130, 132, 140, 142, 150, 152, 210, 220, 230, 232, 240, 242, 402, 404),
at least two driver units (14, 154, 156, 158, 160, 406), and
at least one bus (114, 116, 124, 126, 134, 136, 144, 146, 162, 164, 214, 216, 224, 226, 234, 236, 244, 246, 408), wherein
the at least one microcontroller (12, 110, 120, 130, 132, 140, 142, 150, 152, 210, 220, 230, 232, 240, 242, 402, 404) and the at least two driver units (14, 154, 156, 158, 160, 406) are connected to each other via the at least one bus (114, 116, 124, 126, 134, 136, 144, 146, 162, 164, 214, 216, 224, 226, 234, 236, 244, 246, 408) and a unit (30, 430) for generating the control signals (22, 432) is provided in the at least two driver units (14, 154, 156, 158, 160, 406).

2. The arrangement according to claim 1, wherein the bus (114, 116, 124, 126, 134, 136, 144, 146, 162, 164, 214, 216, 224, 226, 234, 236, 244, 246, 408) is configured such that a direct and/or an indirect connection is established between the at least one microcontroller (12, 110, 120, 130, 132, 140, 142, 150, 152, 210, 220, 230, 232, 240, 242, 402, 404) and the at least two driver units (14, 154, 156, 158, 160, 406).

3. The arrangement according to claim 1, wherein the unit (30, 430) for generating the control signals (22, 432) is configured to generate PWM signals.

4. The arrangement according to claim 1, wherein the at least one bus (114, 116, 124, 126, 134, 136, 144, 146, 162, 164, 214, 216, 224, 226, 234, 236, 244, 246, 408) has a ring structure.

5. The arrangement according to claim 1, wherein the at least one bus (114, 116, 124, 126, 134, 136, 144, 146, 162, 164, 214, 216, 224, 226, 234, 236, 244, 246, 408) has a tree structure.

6. The arrangement according to claim 1, wherein two buses (114, 116, 124, 126, 134, 136, 144, 146, 162, 164, 214, 216, 224, 226, 234, 236, 244, 246, 408) are provided.

7. A method of generating control signals (22, 432) for actuating an output stage (60, 70, 72, 74, 78, 80, 440) for an electric motor (10, 90, 92, 94, 96, 450), the electric motor including:
at least one microcontroller (12, 110, 120, 130, 132, 140, 142, 150, 152, 210, 220, 230, 232, 240, 242, 402, 404),
at least two driver units (14, 154, 156, 158, 160, 406), and
at least one bus (114, 116, 124, 126, 134, 136, 144, 146, 162, 164, 214, 216, 224, 226, 234, 236, 244, 246, 408), wherein the at least one microcontroller (12, 110, 120, 130, 132, 140, 142, 150, 152, 210, 220, 230, 232, 240, 242, 402, 404) and the at least two driver units (14, 154, 156, 158, 160, 406) are connected to each other via the at least one bus (114, 116, 124, 126, 134, 136, 144, 146, 162, 164, 214, 216, 224, 226, 234, 236, 244, 246, 408),
the method comprising:
generating the control signals (22, 432) via a unit provided in the at least two driver units (14, 154, 156, 158, 160, 406).

8. The method according to claim 7, which is used to generate control signals (22, 432) for the electric motor (10, 90, 92, 94, 96, 450) of a brake actuator.

9. The method according to claim 7, which is used to generate control signals (22, 432) for the electric motor (10, 90, 92, 94, 96, 450) of a steering rack actuator.

10. The method according to claim 7, which is used for generating control signals (22, 432) for the electric motor (10, 90, 92, 94, 96, 450) of a driver feedback unit.
